(19) United States
(12) Patent Application Publication
(10) Pub. No.: US 2023/0155115 A1
(43) Pub. Date: May 18, 2023

(54) ELECTRODE MANUFACTURING METHOD AND ELECTRODE

(71) Applicant: TOYOTA JIDOSHA KABUSHIKI KAISHA, Toyota-shi (JP)

(72) Inventors: Momoka ODA, Toyota-shi (JP); Tomoyuki UEZONO, Okazaki-shi (JP)

(73) Assignee: TOYOTA JIDOSHA KABUSHIKI KAISHA, Toyota-shi (JP)

(21) Appl. No.: 17/984,464

(22) Filed: Nov. 10, 2022

(30) Foreign Application Priority Data
Nov. 16, 2021 (JP) 2021-186230

(51) Int. Cl. H01M 4/36; H01M 4/04

(52) U.S. Cl. CPC H01M 4/366; H01M 4/043; H01M 4/0409; H01M 2004/021

(57) ABSTRACT

The first coating material adheres to the surface of the substrate to form a first layer. A first pressing force is applied to the first layer to compress the first layer. The second coating material adheres to the surface of the first layer after compression, thereby forming the second layer. A second pressing force is applied to the second layer to compress the second layer. An active material layer including a first layer and a second layer is formed. The second coating material is dry. The first coating material and the second coating material each independently include an active material and a binder.

### CROSS-REFERENCE TO RELATED APPLICATION

This application claims priority to Japanese Patent Application No. 2021-186230 filed on Nov. 16, 2021, incorporated herein by reference in its entirety.

### BACKGROUND

### 1. Technical Field

The present disclosure relates to an electrode manufacturing method and an electrode.

### 2. Description of Related Art

Japanese Unexamined Patent Application Publication (Translation of PCT Application) No. 2009-525568 (JP 2009-525568 A) discloses a multilayer material comprising at least two layers.

### SUMMARY

An electrode is manufactured by forming an active material layer on a surface of a substrate. An active material layer having a multilayer structure has also been proposed. The multilayer structure includes a plurality of unit layers. The unit layers are stacked in a thickness direction of the active material layer. For example, the composition, the thickness, the density, and the like may be changed for each unit layer. By controlling the composition, the thickness, the density, and the like for each unit layer, battery performance may be improved.

In general, the active material layer (unit layer) is formed by a wet process. That is, a wet coating material is produced by mixing an active material, a binder, a dispersion medium (liquid), and the like. The wet coating material is also referred to as slurry or paste. The wet coating material is applied to the surface of the substrate. Furthermore, the unit layer is formed by drying the wet coating material.

However, in the wet process, it is difficult to precisely control the composition, the thickness, the density, and the like of each unit layer. In the wet process, after drying a lower layer, the wet coating material is applied to a surface of the lower layer. Further, an upper layer is formed by drying the wet coating material. In the process of forming the upper layer, a liquid (a dispersion medium, a binder solution, or the like) contained in the wet coating material may permeate into the lower layer. This may result in mixing of materials between the upper layer and the lower layer. Due to the mixing of the materials, the aimed composition and the like may not be realized.

An object of the present disclosure is to reduce mixing between unit layers in an active material layer having a multilayer structure.

Hereinafter, the technical configuration, operation, effects of the present disclosure will be described. However, the operation mechanism herein includes estimation. The operation mechanism does not limit the scope of the disclosure.

1. An electrode manufacturing method includes the following (a) to (e). (a) A first layer is formed by adhering a first coating material on a surface of a substrate. (b) The first layer is compressed by applying a first pressing force to the first layer. (c) The second layer is formed by adhering a second coating material on a surface of the first layer after compression. (d) The second layer is compressed by applying a second pressing force to the second layer. (e) An active material layer including a first layer and a second layer is formed. The second coating material is in a dry state. The first coating material and the second coating material each independently include an active material and a binder.

In the manufacturing method of “1” described above, the second layer is formed by adhering the second coating material (dry coating material) to the surface of the first layer. The dry coating material substantially does not include liquids. That is, there is substantially no liquid that can permeate the first layer. Thus, the mixing of materials at the interface between the first layer and the second layer can be reduced.

2. The first coating material may be in a dry state.

The first layer (lower layer) may also be formed by a dry process. In the wet process, migration of the binder may occur in the course of evaporation of the dispersion medium (liquid). The term “migration” indicates a phenomenon in which the binder floats on a surface layer of a coating layer. When migration occurs, unevenness may occur in the distribution of the binder in the thickness direction of the active material layer. In the dry process, migration of the binder is believed to not occur. Thus, the first layer that is homogeneous may be formed.

3. The second pressing force may be different from the first pressing force.

Since the second pressing force is different from the first pressing force, the second layer has a different density from the first layer.

4. The second pressing force may be lower than the first pressing force.

Since the second pressing force is lower than the first pressing force, the second layer (upper layer) may have a lower density than the first layer (lower layer). Due to the low density of the upper layer, it is expected that an electrolytic solution easily permeates into the active material layer. As the electrolyte permeates into the active material layer, for example, a reduction in battery resistance is expected. Due to the high density of the lower layer, it is expected that a permeability of the electrolytic solution is balanced with a high energy density.

5. The second coating material may have the same chemical composition as the first coating material.

For example, a first layer and a second layer having different densities may be formed by one kind of coating material. Thereby, the number of parts can be reduced.

6. The first coating material may adhere to the surface of the substrate by electrostatic force. The second coating material may adhere to the surface of the first layer by electrostatic force.

As a method of adhering the dry coating material (powder coating material), for example, electrostatic coating can be considered.

7. The second coating material may have a solid fraction of 95% to 100% by a mass fraction.

The dry state indicates a solid fraction of 95% or more.

8. An electrode includes a substrate and an active material layer. The active material layer is disposed on a surface of a substrate. The active material layer includes a first layer and a second layer. The first layer is disposed between the substrate and the second layer. The second layer is in contact with the first layer. The first layer and the second layer each independently include an active material and a binder. At an interface between the first layer and the second layer, the surface of the first layer is flat.

By pressing the first layer after drying, the surface of the first layer becomes flat. However, when the second layer is formed by the wet process, liquid permeates into the first layer, resulting in mixing of the materials. Thus, disturbance occurs on the surface of the first layer. That is, the surface of the first layer becomes not flat.

In the manufacturing method of “1” described above, the second layer is formed by the dry process. Thus, a flat surface can be maintained at the interface between the first layer and the second layer. As a result, the first layer may be in flush contact with the second layer.

9. At the interface between the first layer and the second layer, the first layer may have a flatness of 1.15 or less. The flatness may be obtained by the following formula (I):

F=L′/L (I)

In the above formula (I), F indicates flatness. L represents a width of the active material layer in a cross section parallel to a thickness direction of the active material layer. L′ represents a length of a contour line of a surface of the first layer at an interface between the first layer and the second layer in a cross section parallel to the thickness direction of the active material layer.

Due to the flatness of “9” described above, the surface of the first layer can be evaluated. The closer the value is to 1, the flatness indicates that the target surface is flat. In the manufacturing method of “1” described above, the flatness of 1.15 or less can be realized. When the second layer is formed by the wet process, the planarity is considered to be greater than 1.15.

10. The second layer may have a density different from the first layer.

11. The second layer may have a density lower than the first layer.

12. The second layer may have the same chemical composition as the first layer.

Hereinafter, an embodiment of the present disclosure (hereinafter, may be abbreviated as the “present embodiment”) and an example of the present disclosure (hereinafter, may be abbreviated as the “present example”) will be described. However, the present embodiment and the present example do not limit the technical scope of the present disclosure.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic flowchart of a manufacturing method an electrode according to the present embodiment;

FIG. 2 is a schematic diagram illustrating an example of an electrostatic coating apparatus;

FIG. 3 is a schematic cross-sectional view showing an electrode in the present embodiment;

FIG. 4 is a cross-sectional SEM image of an electrode in this embodiment;

FIG. 5 is a measurement example of flatness in the present embodiment.

### DETAILED DESCRIPTION OF EMBODIMENTS

### Definition of Terms

As used herein, the description of “comprising,” “including,” “having,” and variations thereof (e.g., “consisting of,” and the like) is open-ended in form. The open-end format may or may not further include additional elements in addition to the essential elements. The description “consisting of” is in closed form. However, even closed forms do not exclude additional elements that are normally associated impurities or are unrelated to the disclosed technology. The statement “consisting essentially of” is in semi-closed form. In the semi-closed format, the addition of elements that do not materially affect the basic and novel properties of the disclosed technology is acceptable.

In the present specification, expressions such as “may” or “may” are used not in an obligatory sense but in an acceptable sense.

In the present specification, unless otherwise specified, the execution order of a plurality of steps, operations, operations, and the like included in various methods is not limited to the description order. For example, a plurality of steps may proceed simultaneously. For example, a plurality of steps may be back and forth.

In the present specification, for example, unless otherwise specified, a numerical range such as “m to n %” includes an upper limit value and a lower limit value. That is, “m to n %” indicates a numerical range of “m % or more and n % or less”. Further, “m % or more and n % or less” includes “more than m % and less than n %”. Further, a numerical value arbitrarily selected from within the numerical range may be a new upper limit value or a new lower limit value. For example, a new numerical range may be set by arbitrarily combining numerical values within the numerical range with numerical values described in other parts, tables, figures, etc. herein.

All numerical values are herein modified by the term “about.” The term “about” may mean, for example, ±5%, ±3%, ±1%, etc. All numerical values may be approximations that may vary depending on the application of the disclosed technology. All numerical values may be indicated by significant numerals. The measurement value may be an average value in a plurality of measurements. The number of measurements may be three or more, five or more, or ten or more. In general, it is expected that the higher the number of measurements, the higher the reliability of the average value. The measurements may be rounded to fractions based on the number of significant digits. The measurement value may include, for example, an error or the like associated with a detection limit or the like of the measurement device.

Geometric terms (e.g., “parallel,” “vertical,” “orthogonal,” etc.) herein should not be construed in a strict sense. For example, “parallel” may deviate somewhat from “parallel” in the strict sense. The geometric terms herein may include, for example, design, work, manufacturing tolerances, errors, and the like. The dimensional relationship in each figure may not coincide with the actual dimensional relationship. In order to facilitate understanding of the technology of the present disclosure, dimensional relationships (length, width, thickness, and the like) in the drawings may be changed. Further, some configurations may be omitted.

As used herein, when a compound is represented by a stoichiometric compositional formula (e.g., “LiCoO₂”), the stoichiometric compositional formula is only representative of the compound. The compound may have a non-stoichiometric composition. For example, when lithium cobaltate is expressed as “LiCoO₂”, unless otherwise specified, lithium cobaltate is not limited to a composition ratio of “Li/Co/O=1/1/2”, and lithium cobaltate may include Li, Co, and O at any composition ratio. In addition, doping and substitution with trace elements and the like may also be tolerated.

“Solid fraction” herein refers to the total mass fraction of components other than liquids. For example, when the coating material includes a dispersion medium (liquid), a binder (solute), a conductive material (dispersoid), and an active material (dispersoid), the solid content of the coating material indicates the total mass fraction of the binder, the conductive material, and the active material with respect to the total mass of the coating material. The solids fraction may be abbreviated as “Nonvolatile content (NVs)”. “Dry state” herein indicates a solids content of 95-100%. The solid content in the dry state may be 98% or more, or may be 99% or more.

In the volume-based particle size distribution, “D50” in the present specification is defined as a particle size in which the cumulative frequency from the smaller particle size reaches 50%.

“Melting point” herein refers to the peak top temperature of the melting peak (endothermic peak) in Differential Scanning calorimetry (DSCs) curve. The DSC-curve can be measured according to “JISK7121”. “About the melting point” may indicate, for example, a range of melting point ±20° C.

The “electrode” in the present specification is a generic term for a positive electrode and a negative electrode. That is, the electrode may be a positive electrode or a negative electrode. The application of the electrode is optional. In the present embodiment, an electrode for a lithium-ion battery is described as an example. The lithium ion battery may be a liquid-based battery or an all-solid-state battery.

### <Electrode Manufacturing Method>

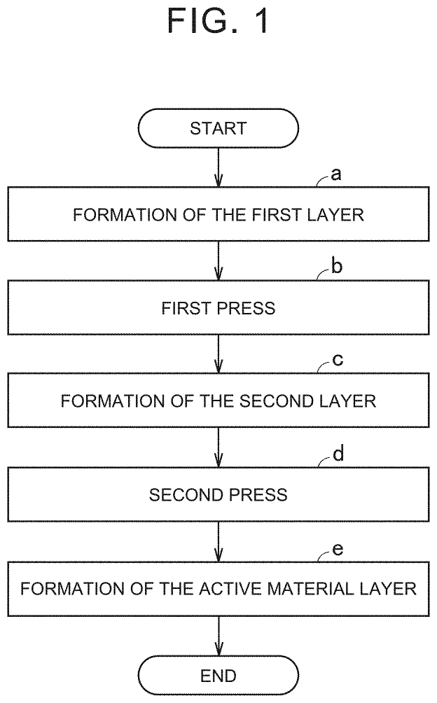

FIG. 1 is a schematic flowchart of an electrode manufacturing method according to the present embodiment. Hereinafter, the “electrode manufacturing method in the present embodiment” may be abbreviated as “the present manufacturing method”. The manufacturing method includes “(a) forming a first layer”, “(b) forming a first press”, “(c) forming a second layer”, “(d) forming a second press”, and “(e) forming an active material layer”.

### (a) Formation of the First Layer

By depositing a first coating material on the surface of the substrate, the manufacturing method includes forming a first layer.

### <Substrate>

The substrate may be, for example, in the form of a sheet. The substrate may have conductivity, for example. The substrate may comprise, for example, a metal foil. The substrate may include, for example, aluminum (Al) foil, copper (Cu) foil, and the like. The substrate may have a thickness of, for example, 5 to 50 μm.

### <First Coating Material>

The first coating material may be a wet coating material or a dry coating material. The first coating material may be a slurry, a wet powder, or a dry powder. The slurry may have a solids content of, for example, 50-70%. The wet powder may have a solids content of, for example, 70-95%. The dry powder may have a solids content of 95-100%. That is, the first coating material may be in a dry state.

For example, a wet coating material may be made by mixing an active material, a binder, and a liquid. For example, a dry coating material may be made by mixing an active material and a binder. That is, the first coating material includes an active material and a binder. The first coating material may further include, for example, a conductive material, a solid electrolyte, and the like.

### Active Materials

The active material may be in powder form, for example. The active material may have a D50 of, for example, 1 to 30 μm. The active material may include, for example, a positive electrode active material. The active material may comprise, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the sum of the compositional ratios in parentheses is 1. As long as the sum is 1, the amounts of the individual components are optional. Li(NiCoMn)O₂, for example, Li(Ni_{1/3} Co_{1/3}Mn_{1/3})O₂, Li(Ni_{0.5}Co_{0.2}Mn_{0.3})O₂, Li(Ni_{0.8}Co_{0.1}Mn_{0.1})O₂, etc.

The active material may include, for example, a negative electrode active material. The active material may include, for example, at least one selected from the group consisting of graphite, soft carbon, hard carbon, silicon, silicon oxide, silicon-based alloys, tin oxide, tin-based alloys, and Li₄Ti₅O₁₂.

### (Binder)

The binder may be in powder form, for example. The binder bonds the solid materials together in the active material layer. The blending amount of the binder may be, for example, 0.1 to 10 parts by mass with respect to 100 parts by mass of the active material. The binder may comprise any component. The binder may include, for example, at least one selected from the group consisting of polyvinylidene fluoride (PVdF), polytetrafluoroethylene (PTFE), vinylidene fluoride-hexafluoropropylene copolymer (PVdF-HFP), styrene butadiene rubber (SBR), carboxymethyl cellulose (CMC), polyimide (PI), polyamideimide (PAI), and polyacrylic acid (PAA).

### <Liquid>

The liquid may, for example, function as a dispersion medium in the slurry or a granulation accelerator in the wet powder. The liquid may, for example, dissolve the binder. The liquid may comprise, for example, at least one selected from the group consisting of water, N-methyl-2-pyrrolidone (NMP), and butyl butyrate. The dry coating material (dry powder) is substantially free of liquid.

### (Optional Components)

The first coating material may further include, for example, an electrically conductive material. The conductive material may be in the form of a powder, for example. The conductive material may form an electron conduction path in the active material layer. The blending amount of the conductive material may be, for example, 0.1 to 10 parts by mass with respect to 100 parts by mass of the active material. The conductive material may include any component. The conductive material may include, for example, conductive carbon particles, conductive carbon fibers, and the like. The conductive material may include, for example, at least one selected from the group consisting of carbon black, vapor-grown carbon fibers, carbon nanotubes, and graphene flakes. The carbon black may include, for example, at least one selected from the group consisting of acetylene black, furnace black, channel black, and thermal black.

The first coating material may further include, for example, a solid electrolyte. The solid electrolyte may be in powder form. The solid electrolyte may form an ion conduction path in the active material layer. The solid electrolyte may comprise any component. The solid electrolyte may, for example, comprise at least one selected from the group consisting of Li₂S—P₂S₅, LiI—Li₂S—P₂S₅, LiBr—Li₂S—P₂S₅, LiI—LiBr—Li₂S—P₂S₅.

### <Composite Powder>

When the first coating material is a dry powder, the first coating material may be a composite powder. The composite powder may be formed by compounding an active material and other solid materials. For example, the composite powder can be formed by adhering a binder, a conductive material, and the like to the surface of the active material (particles). For example, a composite powder can be formed by mixing an active material and other solid materials under conditions where a strong shear force is applied. After the formation of the composite powder, the composite powder may be subjected to a heat treatment, for example, at a temperature near the melting point of the binder. The heat treatment softens, melts, and re-solidifies the binder. As a result, it is expected that the binder, the conductive material, and the like are firmly fixed to the surface of the active material.

### Attachment Method

In the present manufacturing method, the first coating material may be adhered to the surface of the substrate by any method. When the first coating material is a slurry, the slurry may be applied to the surface of the substrate by, for example, a die coater. When the first coating material is a wet powder, the wet powder may be applied to the surface of the substrate by, for example, a roll coater or the like.

When the first coating material is a dry powder, the dry powder may be applied to the surface of the substrate, for example, by electrostatic coating. In electrostatic coating, the dry powder adheres to the surface of the substrate by electrostatic force. That is, in the present manufacturing method, the first coating material may adhere to the surface of the substrate by electrostatic force. In this embodiment, electrostatic coating is described as an example of a dry process.

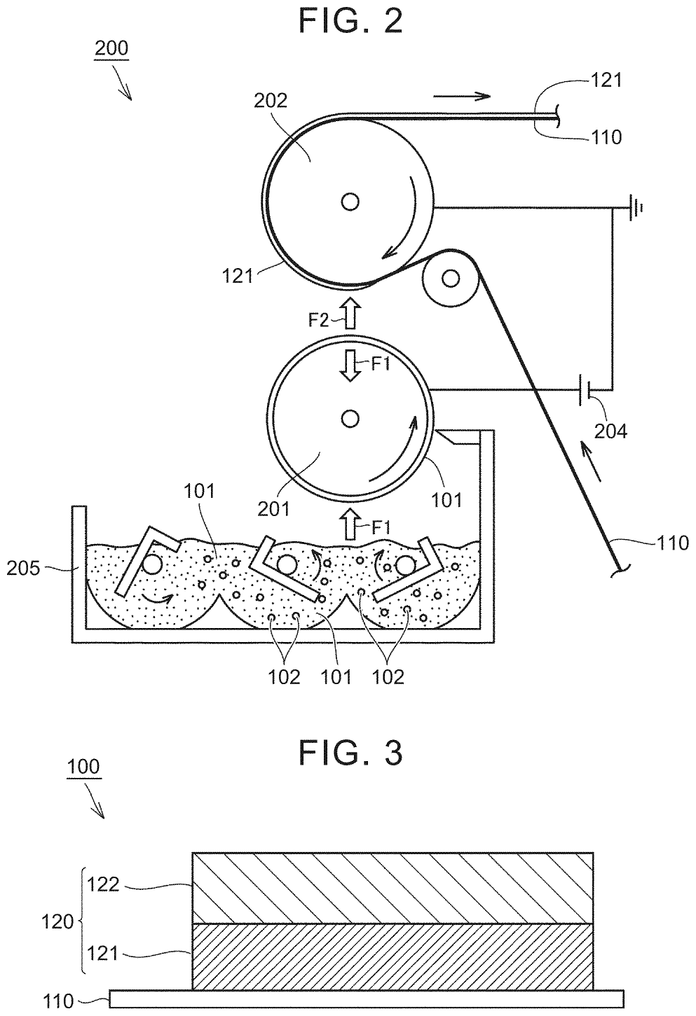

FIG. 2 is a schematic diagram illustrating an example of an electrostatic coating apparatus.

The electrostatic coating apparatus 200 includes a container 205, a first roll 201, a second roll 202, and a power source 204. For example, the composite powder 101 (first coating material or second coating material) is supplied to the container 205. In the container 205, the composite powder 101 may be agitated. For example, in the container 205, the composite powder 101 may be mixed with a magnetic powder (hereinafter, also referred to as “magnetic carrier”). The magnetic carrier 102 includes a ferromagnetic material. The composite powder 101 may adhere to the surface of the magnetic carrier 102.

The first roll 201 includes a magnet. The first roll 201 may also be referred to as a “magnet roll.” The magnetic force F1 from the first roll 201 causes the magnetic carrier 102 to be attracted to the surface of the first roll 201. As a result, the composite powder 101 is disposed on the surface of the first roll 201. The power source 204 applies a DC voltage between the first roll 201 and the second roll 202. Thus, an electric field is formed between the first roll 201 and the second roll 202. The power source 204 supplies a charge to the first roll 201. Charge is injected into the composite powder 101 on the surface of the first roll 201.

The first roll 201 rotates in the direction of the arrow. By the rotation of the first roll 201, the composite powder 101 is conveyed to the gap between the first roll 201 and the second roll 202. An electric field is formed between the first roll 201 and the second roll 202. As the composite powder 101 is introduced into the electric field, the electrostatic force F2 acts on the composite powder 101. The electric field is formed such that the electrostatic force F2 is greater than the magnetic force F1. As a result, the composite powder 101 may be detached from the surface of the first roll 201.

The second roll 202 rotates in the direction of the arrow. By the rotation of the second roll 202, the substrate 110 is conveyed to the gap between the first roll 201 and the second roll 202. The composite powder 101 separated from the first roll 201 flies toward the substrate 110. The composite powder 101 adheres to the surface of the substrate 110. Accordingly, the first layer 121 may be formed.

### (b) First Press

By applying a first pressing force to the first layer, the manufacturing method includes compressing the first layer. For example, the first layer may be compressed by roll pressing. The first pressing force may be, for example, 1 to 10 kN. By dividing the first pressure by the width of the first layer, the first roll linear pressure is determined. The first roll linear pressure may be, for example, 0.2 to 2 kN/cm. During pressing, the first layer may be heated. Pressure and heat are applied to the first layer. Thus, for example, the fixing strength of the first layer is expected to be improved. For example, the first layer may be pressed by a heat roll or the like. The heating temperature may be, for example, a temperature near the melting point of the binder. The heating temperature may be, for example, 100 to 200° C.

### (c) Formation of the Second Layer

By depositing a second coating material on the surface of the first layer after compression, the manufacturing method includes forming a second layer. For example, electrostatic coating may be performed. That is, in the present manufacturing method, the second coating material may adhere to the surface of the first layer by electrostatic force. Details of the electrostatic coating are as described above.

### <Second Coating Material>

The second coating material is dry. The second coating material has a solids content of 95-100%. The second coating material may be a dry powder. The second coating material includes an active material and a binder. The second coating material may be a composite powder. Details of the active material and the like are as described above. By forming the second layer by a dry process, mixing at the interface between the first layer and the second layer may be reduced.

The second coating material may have a different chemical composition than the first coating material. Accordingly, a second layer having a chemical composition different from that of the first layer may be formed. For example, the type of the active material may be different between the second coating material and the first coating material. For example, the mixing ratio of the active material and the binder may be different between the second coating material and the first coating material. The second coating material may have the same chemical composition as the first coating material. As a result, a second layer having the same chemical composition as that of the first layer can be formed.

### (d) Second Press

By applying a second pressing force to the second layer, the manufacturing method includes compressing the second layer. For example, the second layer may be compressed by a roll press. The second pressing force may be the same as the first pressing force. The second pressing force may be different from the first pressing force. Thus, a second layer having a density different from that of the first layer may be formed. The second pressing force may be lower than the first pressing force. Thus, a second layer having a lower density than the first layer may be formed. The second pressing force may be, for example, 0.1 to 1 kN. By dividing the second pressing force by the width of the second layer, the second roll linear pressure is obtained. The second roll linear pressure may be, for example, 0.02 to 0.2 kN/cm. The second layer may be heated during pressing. Pressure and heat are applied to the second layer. Thus, for example, it is expected that the fixing strength of the second layer is improved. For example, the second layer may be pressed by a heat roll or the like. The heating temperature may be, for example, a temperature near the melting point of the binder. The heating temperature may be, for example, 100 to 200° C.

### (e) Formation of an Active Material Layer

The manufacturing method includes forming an active material layer including a first layer and a second layer. For example, the active material layer may be completed by forming the first layer and the second layer. That is, the active material layer may be composed of a first layer and a second layer. For example, the third layer, the fourth layer, and the like may be further formed on the second layer by repeating the above-described steps (c) to (d) after the formation of the first layer and the second layer.

### <Electrode>

FIG. 3 is a schematic cross-sectional view showing an electrode according to the present embodiment.

Hereinafter, the “electrode in the present embodiment” may be abbreviated as “the present electrode”. The electrode 100 can be manufactured by the present manufacturing method. The electrode 100 includes a substrate 110 and an active material layer 120. The details of the substrate 110 are as described above. The active material layer 120 is disposed on the surface of the substrate 110. The active material layer 120 may be disposed on only one surface of the substrate 110, or may be disposed on both front and back surfaces.

The active material layer 120 includes a first layer 121 and a second layer 122. As long as the active material layer 120 includes the first layer 121 and the second layer 122, the active material layer 120 may further include a third layer, a fourth layer (not shown), and the like. For example, a third layer may be laminated on the second layer 122. For example, a fourth layer may be laminated on the third layer.

The first layer 121 is so to speak a lower layer. The first layer 121 is disposed between the substrate 110 and the second layer 122. That is, the first layer 121 is closer to the substrate 110 than the second layer 122. The first layer 121 may be formed directly on the surface of the substrate 110.

The second layer 122 is, in other words, an upper layer. The second layer 122 is stacked on the first layer 121. The second layer 122 is closer to the surface of the active material layer 120 than the first layer 121. The second layer 122 may include a surface of the active material layer 120.

The second layer 122 is in contact with the first layer 121. At the interface between the first layer 121 and the second layer 122, the surface of the first layer 121 is flat. Thus, the first layer 121 may be in flush contact with the second layer 122.

The first layer 121 may have a planarity of, for example, 1.15 or less. A smaller flatness value indicates that the flatness is flat. The first layer 121 may have a planarity of, for example, 1 to 1.15, or may have a planarity of 1 to 1.10.

The flatness is determined by the above formula (I). L and L′ in the above formula (I) are measured in the cross section of the electrode 100. The sample is cut out from the main electrode 100. The sample includes a cross section (observation target surface) parallel to the thickness direction of the active material layer 120. The observation target surface is planarized. For example, Cross-section Polisher (CP) processing may be performed on the surface to be observed. After planarization, the surface to be observed is observed by Scanning Electron Microscope (SEMs). Thus, the cross-sectional SEM image is acquired. In cross-sectional SEM images, L and L′ are measured. The observation magnification can be adjusted according to the thickness of each layer, the thickness of the active material layer, the width, and the like. The observation magnification may be, for example, 100 to 1000 times.

The first layer 121 and the second layer 122 may have any thickness. Each of the first layer 121 and the second layer 122 may independently have a thickness of, for example, 5 to 200 μm, or may have a thickness of 10 to 100 μm. The second layer 122 may be thicker than the first layer 121, for example. The second layer 122 may be thinner than the first layer 121, for example.

The first layer 121 and the second layer 122 may have any density. The second layer 122 may have the same density as the first layer 121. The second layer 122 may have a density different from that of the first layer 121. The second layer 122 may have a lower density than the first layer 121. It is expected that the low density of the second layer 122 facilitates penetration of the electrolytic solution into the active material layer 120. It is expected that the high density of the first layer 121 balances the permeability of the electrolytic solution with the high energy density. The second layer 122 may have a density of, for example, 1-2.5 g/cm³, or may have a density of 1.5-2.0 g/cm³. The first layers 121 may have a density of, for example, 2.5-4.0 g/cm³, or may have a density of 2.5-3.0 g/cm³.

The first layer 121 and the second layer 122 each independently include an active material and a binder. The second layer 122 may have a chemical composition different from that of the first layer 121, for example. The second layer 122 may have, for example, the same chemical composition as the first layer 121. Each of the first layer 121 and the second layer 122 may independently further include a conductive material, a solid electrolyte, or the like. Details of the active material and the like are as described above.

### <Manufacture of Electrodes>

### (a) Formation of the First Layer

The following materials were prepared:

Active material:Li(NiCoMn)O₂
Conductive material: acetylene black

### Binder: PVdF

Substrate: Al foil

Particle compounding equipment (product name “Multi per Pass Mixer”, manufactured by Nippon Coke Industries Co., Ltd.) was prepared. In the particle compounding apparatus, the composite powder was produced by mixing the active material, the conductive material, and the binder. The mixing ratio was “active material/conductive material/binder=93.5/1.5/5 (mass ratio)”. The mixing time in the particle compounding apparatus was 10 minutes. The rotational speed was 10000 rpm. In this example, the composite powder was used as a first coating material and a second coating material.

14.2 parts by weight of the first coating material and 85.8 parts by weight of the magnetic carrier were charged into a plastic container. The plastic container was placed on the table-top turntable. The plastic container was rotated at 277 rpm for 30 minutes.

An electrostatic coating apparatus 200 was prepared (see FIG. 2). A mixture of the first coating material (composite powder 101) and the magnetic carrier 102 was supplied to the container 205. Due to the electrostatic force F2, the first coating material (composite powder 101) adhered to the surface of the substrate 110. Thus, the first layer 121 was formed. The rotation speed of the first roll 201 (magnet roll) was 100 rpm.

### (b) First Press

A roll press was prepared. The roll press comprises a heat roll. The temperature of the heat roll was set at 160° C. A first pressing force was applied to the first layer by roll pressing. This compressed the first layer. The first pressing force was 7 kN. The first roll linear pressure was 1.17 kN/cm.

### (c) Formation of the Second Layer

A second coating material was prepared. The second coating material was the same composite powder as the first coating material. By using the electrostatic coating apparatus 200 (FIG. 2), the second coating material (composite powder 101) adhered to the surface of the first layer 121. As a result, the second layer 122 was formed (see FIG. 3). The second layer 122 had the same chemical composition as the first layer 121.

### (d) Second Press

A roll press was prepared. The roll press comprises a heat roll. The temperature of the heat roll was set at 160° C. A second pressing force was applied to the second layer by roll pressing. Thus, the second layer was compressed. The second pressing force was 0.7 kN. The second roll linear pressure was 0.117 kN/cm.

### (e) Formation of an Active Material Layer

As described above, the active material layer including the first layer and the second layer was formed. The specifications of the active material layer are shown in Table 1 below.

TABLE 1
Table 1

| | Basis weight | Thickness | Density | Flatness |
|---|---|---|---|---|
| | mg/cm² | gm | g/cm³ | — |
| Layer 1 | 6 | 21.9 | 2.7 | 1.15 |
| Second layer | 6 | 30 | 2.0 | — |

### <Evaluation>

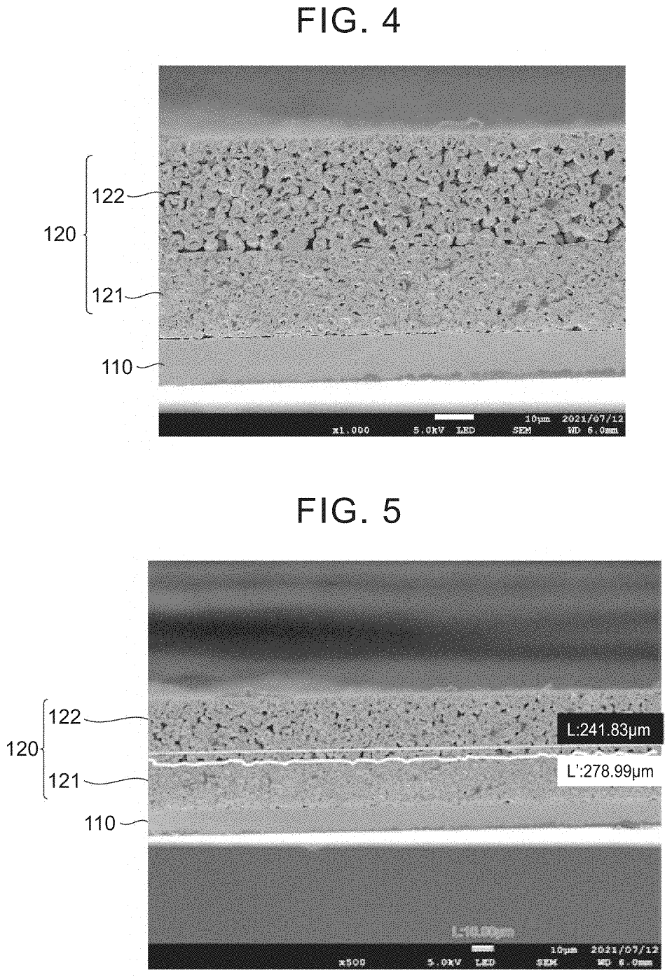

FIG. 4 is a cross-sectional SEM image of the electrode in this embodiment. It can be seen that the surface of the first layer 121 is flat. It is conceivable that mixing is unlikely to occur between the first layer 121 and the second layer 122.

FIG. 5 is a measurement example of flatness in the present embodiment. In the cross-sectional SEM image, the width (L) of the active material layer 120 was 241.83 μm. The width (L) represents a length of the active material layer 120 in a direction orthogonal to the thickness direction. The width (L) is the total width of the active material layer 120 in the cross-sectional SEM image. The contour length (L′) of the surface of the first layer 121 was 278.99 μm. From the above formula (I), the flatness (F) is 1.15.

The present embodiment and the present example are exemplified in all respects. The present embodiment and the present example are not restrictive. The technical scope of the present disclosure includes all modifications within the meaning and range equivalent to the description of the claims. For example, it is planned from the beginning that arbitrary configurations are extracted from the present embodiment and the present example, and those configurations are arbitrarily combined.

What is claimed is:

1. An electrode manufacturing method comprising:
(a) forming a first layer by adhering a first coating material on a surface of a substrate;
(b) compressing the first layer by applying a first pressing force to the first layer;
(c) forming a second layer by applying a second coating material to a surface of the first layer after compression;
(d) compressing the second layer by applying a second pressing force to the second layer; and
(e) forming an active material layer including the first layer and the second layer,
wherein the second coating material is in a dry state, and
wherein the first coating material and the second coating material each independently include an active material and a binder.

2. The electrode manufacturing method according to claim 1, wherein the first coating material is in a dry state.

3. The electrode manufacturing method according to claim 1, wherein the second pressing force is different from the first pressing force.

4. The electrode manufacturing method according to claim 1, wherein the second pressing force is lower than the first pressing force.

5. The electrode manufacturing method according to claim 1, wherein the second coating material has the same chemical composition as the first coating material.

6. The electrode manufacturing method according to claim 1,
wherein the first coating material adheres to the surface of the substrate by electrostatic force, and
wherein the second coating material adheres to the surface of the first layer by electrostatic force.

7. The electrode manufacturing method according to claim 1, wherein the second coating material has a solid fraction of 95% to 100% by a mass fraction.

8. An electrode comprising:
a substrate; and
an active material layer,
wherein the active material layer is disposed on a surface of the substrate,
wherein the active material layer includes a first layer and a second layer,
wherein the first layer is disposed between the substrate and the second layer,
wherein the second layer is in contact with the first layer,
wherein the first layer and the second layer each independently include an active material and a binder, and
wherein a surface of the first layer is flat at an interface between the first layer and the second layer.

9. The electrode according to claim 8,
wherein at the interface between the first layer and the second layer, the first layer has a flatness of 1.15 or less,
wherein the flatness is obtained by a formula (I):
F=L′/L, and
wherein in the formula (I),
F represents the flatness,
L represents a width of the active material layer in a cross section parallel to a thickness direction of the active material layer, and
L′ represents a length of a contour line of the surface of the first layer at the interface between the first layer and the second layer, in the cross section parallel to the thickness direction of the active material layer.

10. The electrode according to claim 8, wherein the second layer has a density different from the first layer.

11. The electrode according to claim 8, wherein the second layer has a density lower than the first layer.

12. The electrode according to claim 8, wherein the second layer has the same chemical composition as the first layer.
